(19) United States
(12) Patent Application Publication
(10) Pub. No.: US 2009/0253425 A1
(43) Pub. Date: Oct. 8, 2009

(54) METHOD AND SYSTEM FOR REDUCING THE RADIATION WITHIN CELLS OF A CELLULAR NETWORK

(76) Inventor: Shmuel GOLDSHTEIN, Lod (IL)

Correspondence Address: MERCHANT & GOULD PC, P.O. BOX 2903, MINNEAPOLIS, MN, 55402-0903, US

(21) Appl. No.: 12/062,134

(22) Filed: Apr. 3, 2008

(51) Int. Cl. H04Q 7/22

(52) U.S. Cl. 455/426.1

(57) ABSTRACT

A system reduces the amount of RF radiation within a cell of a cellular network located in an urban area and servicing users of cellphones. The system includes dedicated access devices, each of which emulates a mini-base station of a cell and connected to a data network via an access point deployed in the vicinity of users. The access devices detect and communicate with subscribers, being users of cellphones with a unique identifier that are within its communication range; (b) diverting cellular calls of subscribers to which priority has been given, from the BS of the cell to data channels of the data network upon detecting the unique identifier. The system has a multiplexer that is connected to the data channels, for identifying the corresponding cellular operator of each subscriber and routing the cellular calls to the cellular switch of the corresponding cellular operator.

### FIELD OF THE INVENTION

The present invention relates to the field of Cellular Networks. More particularly, it relates to a method and system for reducing the amount of RF radiation within cells of a cellular network (particularly GSM) located in urban areas by reducing the number of mini base stations within the cell.

### BACKGROUND OF THE INVENTION

### Definitions

ASTN (Automatic Switched Transport Network): Defines means which allows traffic paths to be set up through automatically on a switched network. ASTN allows specifying the start and the end points, and the required bandwidth.
BS or BTS or CBS (Base Station or Base Transceiver Station or Cellular Base Station): Device that maintains and manages communications (transmission/reception) with mobile phones in a define area called “cell”.
   MBS (“Mini Base Station”): Device that manages a sub-cell signal area. It allows reducing the BS load.
BSC (Base Station Controller): Device which is a part of a wireless. It controls some BS. It allows reducing the load on a switch.
CATV (Community Access Television or Cable TV): Defines an increasingly way to interact with the Internet and others forms of multimedia information and services.
Cell (or Cell Site): A cellular system basic geographic unit. A cell is a division of a cell phones operator service area. Each one is define by a BS.
   Minicell: define a MBS area.
GSM (Global System for Mobile communication): is a digital mobile telephony system that digitizes and compresses data, then sends it down a channel with two other streams of user data, each in its own time slot.
Ethernet: Defines the most widely-installed LANs (Local Area Network) technology. An Ethernet LAN typically uses coaxial cable or twisted pair wires. Devices are connected by these cables and exchanges data according to a specific network protocol (CSMA/CD.
Gateway: Device which allows connecting two (or more) different networks.
IMSI (International Mobile Subscriber Identity): Defines a unique number associated with all cellphones and more particularly users. It is stored in the SIM inside the cellular. The IMSI is sent to the network to allow identification and location by the way of BSs or MBSs. The IMSI is usually 15 digits long and contains data related to the user (subscription country and operator and subscriber identifier).
IR (Ionizing Radiation): High electromagnetic energy radiation. IR strips electrons away from their normal locations in atoms and molecules.
Land Line (or Wire Line): Traditional wired phone service.
LEC (Local Exchange Carrier): Defines a public telephone company providing local service. Lines from clients terminate at a local exchange switch. This one connects to another one within a Local Access and Transport Area (LATA) or to interexchange carriers (IXCs) for long-distance.
Multiplexer (or multiplexer-demultiplexer) is a device that performs multiplexing; it selects one of many input signals and outputs that into a single line. A demultiplexer works conversely input signal and outputs that into many lines. These two systems can be combined.
Network: Defines a system which provides access paths for communication between users. Communication networks may be designed for data, voice and video. They may be private with a limited access or public with an open access.
PSTN (Public Switched Telephone Network): Defines the traditional landline network.
Repeater: Device that receives a signal amplifies it and retransmits it in a new direction. A MBS can be considered as a repeater.
SIM (Subscriber Identity Module): Device which is a removable smart card integrated circuit card, known as SIM Cards. This device securely store the IMSI used to identify a subscriber.
Switch: Device which allows to open, to close or to select paths or others devices in a circuit such as a network.
Transceiver: Equipment to handle the radio signals of a communication flow (emissions and receptions).

Cellphones and cellular networks communicate through electromagnetic radio waves. Usually, the minimum infrastructure needed is a BS generally mounted on a high structure such as a building or a dedicated tower. The area around is called a cell (101). When a user of a cellphone initiates an outgoing call or when receiving an incoming call, its transceiver communicates with the BS of the nearest cell, for obtaining a call channel. Therefore, the BS at that cell faces a demand to add more and more channels, in order to provide service to all active cellphones. Since the capacity of a typical BS is limited to handle up to 1000 concurrent calls, it cannot handle up growing demands for further channels, especially in urban areas (users at home, offices, malls), where each cell is congested with much more demanding cellphone users. In order to maintain a desired quality of service in urban areas, cellular providers install several repeaters or MBSs each few thousands meters smaller base stations in each urban cell. These repeaters allow increasing the signal quality exchanged between the BS and the cellphones. During a call, a particular cellphone can be successively connected to few MBS in a same cell. However, an increasing number of MBS in an urban area increases installation and maintenance costs and introduces environmental and public health problems, due to that fact that each MBS emits RF radiation. Therefore, it is desired to reduce the mummer of such MBSs in cells located in urban areas.

It is an object of the present invention to provide a method and system for reducing the number of MBSs required for maintaining the quality of service within a cell in urban areas.

It is another object of the present invention to provide a method and system for reducing the amount of RF radiation emitted within a cell in urban areas while maintaining the quality of service.

It is a further object of the present invention to provide a method and system for reducing cost of infrastructure required for maintaining the quality of service in cells located in urban areas.

It is still another object of the present invention to provide a method and system for optimizing the usage of BSs in cells located in urban areas.

It is yet an object of the present invention to provide a method and system for reducing the cost of cellular services provided within a cell in urban areas.

Further objects and advantages of this invention will appear as the description proceeds.

### SUMMARY OF THE INVENTION

The present invention is directed to a system for reducing the amount of RF radiation within a cell of a cellular network located in an urban area and servicing users of cellphones, that comprises a plurality of dedicated access devices, each of which emulates a mini-base station of a cell and connected to a data network via an access point deployed in the vicinity of users, for (a) detecting and communicating with subscribers, being users of cellphones with a unique identifier that are within its communication range; (b) diverting cellular calls of subscribers to which priority has been given, from the BS of the cell to data channels of the data network upon detecting the unique identifier and a multiplexer that is connected to the data channels, for identifying the corresponding cellular operator of each subscriber and routing the cellular calls to the cellular switch of the corresponding cellular operator.

The data network communication may be ADSL, ADSN, Ethernet, CATV or WiFi.

Preferably, the dedicated access device includes a transceiver for communicating with the cellphones of subscribers; a filter for detecting unique identifiers and provide access only to subscribers with a unique identifier; a software component for controlling data transfer between the data channel and the cellphones of subscribers; and a voice gateway for converting RF signals to voice packets and vice versa.

The unique identifier may be allocated to a subscriber by his cellular provider and deployed in a format that complies with the IMSI. It also may be downloaded wirelessly into the SIM of the cellphone of the subscriber.

The dedicated access device may provide roaming services to a subscriber by allowing the multiplexer that is connected to a cellular provider in a foreign country to connect the subscriber to the switch of the cellular provider in his origin country.

Preferably, the unique identifier comprises a generic portion that can be detected by any dedicated access device.

The proposed system may be used to provide cellular connection to subscribers being in an area which is not covered by a cell through one or more dedicated access devices connected to a data network in the area. The registration process of subscribers' cellphones is performed to one or more dedicated access devices connected to a data network.

All the above and other characteristics and advantages of the invention will be further understood through the following illustrative and non-limitative description of preferred embodiments thereof, with reference to the appended drawings.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 (prior art) schematically illustrates a typical architecture of a Cell outside an urban area;

FIG. 2 (prior art) schematically illustrates a typical architecture of a cell in an urban area;

FIG. 3 (prior art) schematically illustrates a typical architecture of a cellular infrastructure in a wider area; and

FIG. 4 schematically illustrates architecture of the system for reducing the amount of RF radiation within cells of a cellular network located in urban areas, according to a preferred embodiment of the present invention.

### DETAILED DESCRIPTION OF PREFERRED EMBODIMENTS

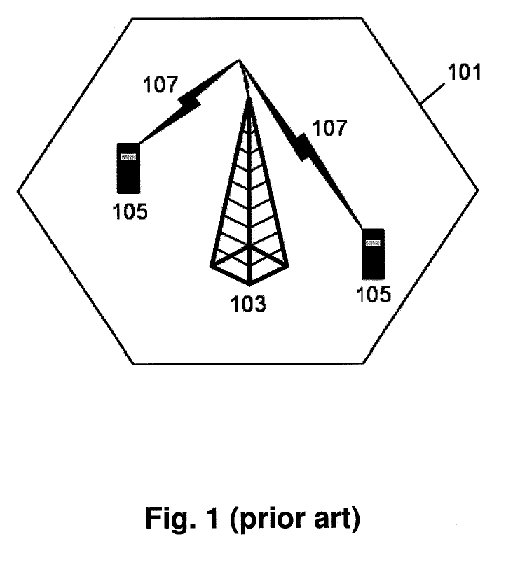

FIG. 1 (prior art) schematically illustrates a typical architecture of a Cell outside an urban area. A plurality of activated cellphones 105 are distributed within cell 101 (typically with a radius around 5 Km) while each cellphone 105 registers on BS 103 for getting services when desired. The amount of RF radiation emitted by BS 103 is proportional to the usage level of the base station. This level is relatively not problematic since in most cases, each user is relatively far from the BS 103.

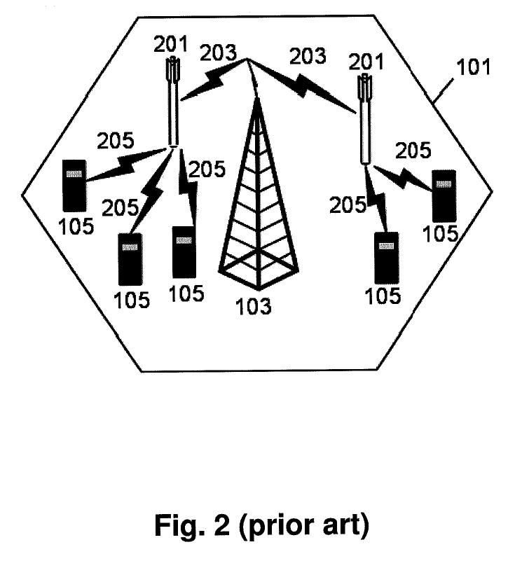

FIG. 2 (prior art) schematically illustrates a typical architecture of a cell in an urban area. Here, the density of cellphones is higher and therefore, BS 103 cannot support all users at the same time. Therefore, additional repeaters or MBSs 201 are deployed in several places within the cell, each of which covering a sub-area of the cell, in order to avoid overload on the BS 103, which in many cases leads to denial of service. In this deployment, the amount of RF radiation emitted by MBS 201 is problematic, since each user is relatively close to the MBS 201 which provides him services.

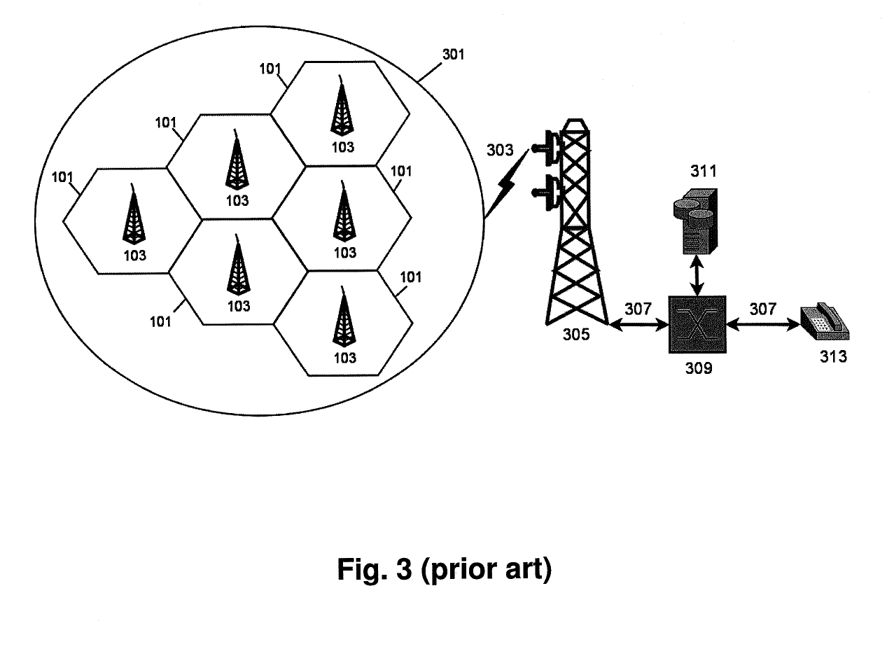

FIG. 3 (prior art) schematically illustrates a typical architecture of a cellular infrastructure in a wider area. A user located in a cell 101 in a sub-area (301) of a cellular network operator is covered by the BS 103 of the related cell. When he submits a call to the BS 103, if a channel is available the BS 103 allocates it to the user. All call from all cells are routed to BSC 305 which receives them and transfers them to the switch 309 of that cellular operator, which further connects all channels of active users to a PSTN 309 of the LEC. The billing center 311 of that cellular operator is in data communication with switch 309, in order to provide relevant data about each call (such as the SIM details, total air-time of incoming and outgoing calls, BS identifiers etc.) for billing purposes. A similar process is conducted the reverse way, when the user receives an incoming call.

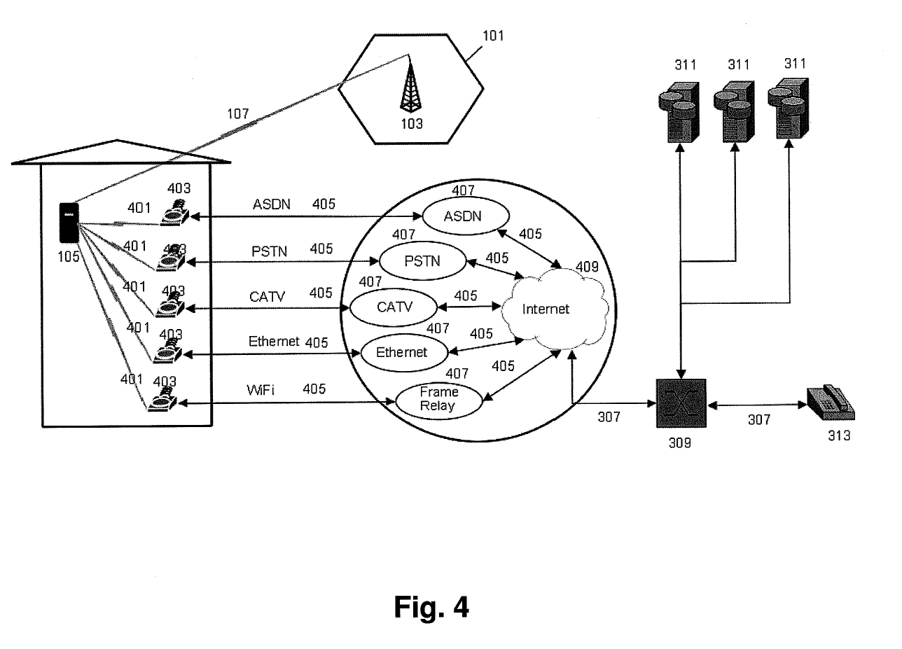

FIG. 4 schematically illustrates architecture of the system for reducing the amount of RF radiation within cells of a cellular network located in urban areas, proposed by the present invention. At the first stage, each cellular user that (from economical reasons) wishes to be a subscriber to the service proposed by the present invention gets a unique device identification which is stored on his regular SIM card, in addition to the conventional data already stored.

### DI (Device Identification):

DI is a soft code stored (e.g., by wirelessly downloading a file) to a subscriber SIM card. The DI allows the cellular operator to sort different cellular users, identify and bill the subscriber using the conventional billing system of his provider. DI is deployed in a format that complies with the IMSI (International Mobile Subscriber Identity—a unique code that consists of the Mobile Country Code, the Mobile Network Code and the Mobile Subscriber Identity Number), which is stored in the SIM and used to identify an individual user on a cellular network. For example, the first portion of the code may be generic, in order to allow worldwide cellular providers to identify each subscriber and allow him accessing the data network in any country. The rest of the DI code is normally unique for each local cellular operator and is allocated and managed by each local cellular operator independently. The DI code is adapted to comply with his existing billing system and may include data for identifying the subscriber and bestowing him through the billing system.

According to a preferred embodiment of the present invention, when a user's cellphone 105 initiates call to a destined recipient 313 (in this example, having a landline telephone), the user dials the phone number and transmits it in a conventional way to the cellular network of his provider. The emitted signal 107 representing a request for connection is received by the nearest BS 103 of the user's cellular operator, where the user's cellphone is registered (the user's cellphone can be registered in more than one cell, in order to assure smooth transition between cells). If the cellphone user 105 is a subscriber to the service proposed by the present invention, the BS 103 checks whether this subscriber's DI has been detected by an indoor communication adapter 403 and if detected, gives that subscriber priority regarding directing the call that corresponds to this request 401 to that adapter 403 which emulates a nearer base station. The wireless cellphone signal 401 is then routed by the DAD 403 to an appropriate data communication channel 405 which is connected to a corresponding data network 407.

The communication adapter 403 is actually a Dedicated Access Device (DAD) which may be implemented in several ways, described below:

### Dedicated Access Device (DAD):

The DAD 403 is a small access device with an RF transceiver that is connected to a standard telephone socket and emulates an indoor mini-cell with a typical detection range of 200-100 m. This access device has two standard telephone plugs, a first one (incoming line) for connection with a standard telephone line and a second one (outgoing line) for connection to a standard telephone device. The DAD is operates as a bridge connecting a standard mobile phone with the corresponding service provider through high-speed broadband data networks rather than through the wireless cellular infrastructure. The DAD 403 is able to detect whether there are cellular signals emitted from one or more user's cellphones in its vicinity, sort them and if a DI is received, to connect to the corresponding cellular switch and inform the operator of that switch that the subscriber with that DI should get a priority to be connected via one of the data networks, rather than the traditional way. Therefore, that subscriber will shift his registration from the BS 103 to register in the DAD 403.

Due to the fact that cellular service providers operate within in a licensed spectrum of frequencies, the DADs will be distributed exclusively by service providers themselves. The output power of each DAD is between 2 and 8 mW and can be calculated like an indoor device.

According to the invention, 4 types of DADs have been designed to fulfill all needs:

DAD(1.2) will be the basic device. A client purchases a mobile phone from the operator offering affordable communication rates. The operator instructs the client to install a DAD, this will then offer the client discounted communication rates and coverage within the limits of the house especially in 3G mobile protocol. The subscriber plugs the DAD into a telephone socket, he then calls the operators service center and informs the center about the telephone number to which the device is connected. Then the ADSL router is synchronized and the SIP client (which is a communication protocol between each DAD and the NM 309) is registered on the NM 309. The voice gateway is a hardware that generates voice packets to be transmitted to and from the subscriber's cellphone over the data network Each DAD has a light on the panel and will blink until the DAD is registers and ready to work.

The mini-cell accepts the signal from the mobile phone and the DI sends IMSI to the NM. The Networks Multiplexer opens the IMSI and sends a signal to the operator (the NM is connected to all national mobile operators and to NM in other countries).

The most popular DAD will be the DAD1 shown below:

[symbol]

MINI CELL
DI FILTER
SIP CLIENT
ADSL ROUTER
ADSL FILTER
VOICE GATEWAY

Each DAD emulates a mini-base station in which a DI subscriber registers and includes a DI filter for providing access to any DI subscriber while excluding all other regular cellular users (that do nor have a DI) from service. In addition, it includes a data communication component to connect to the relevant data network and a voice gateway, for converting the cellular information to voice packets and vice versa.

DAD1 has three versions:
1. DAD1.2—for providing services to 2-4 simultaneous conversations (1 Digital Sound Processor)
2. DAD1.4—for 4-8 simultaneous conversations (2 DSP Digital Sound Processors)
3. DAD1.8—for 30 simultaneous conversations (8 DSP Digital Sound Processors)

Another DAD will be the DAD2 shown below:

[symbol]

MINI CELL
DI FILTER
SIP CLIENT
CM/Router
VOICE GATEWAY

DAD2 is basically similar to DAD1 but uses cable modem/router and also has three versions:
1. DAD2.2—for 2-4 simultaneous conversations (1 DSP Digital Sound Processor)
2. DAD2.4—for 4-8 simultaneous conversations (2 DSP Digital Sound Processor)
3. DAD2.8—for 30 simultaneous conversations (8 DSP Digital Sound Processor)

Another DAD will be the DAD3 shown below:

[symbol]

MINI CELL
DI FILTER
SIP CLIENT
WI-FI MODULE
VOICE GATEWAY

DAD 3 devices have additional services, in a WI-FI environment. DAD3 design is analogue to smart phones and is supplied with an LCD 2.5″ screen. The keyboard and the independent power supply offer 2 hours of continuous conversations or 8 hours at standby mode.

Another DAD will be the DAD4 shown below:

[symbol]

MINI CELL
DI FILTER
SIP CLIENT
VOICE GATEWAY

DAD4 is the smallest and most simple DAD and is intended for providing services with direct Ethernet connections. DAD4 has a standard RJ-45 connection for Ethernet networks and is adjusted automatically. DAD4 is mostly intended to clients being outside of the operator coverage zone and receives services from the national operator while roaming. Once a roaming DI subscriber is detected by DAD4 in a specific country, the NM in that country connects him through DAD4 and the relevant data network back to the cellular switch of his cellular operator in his origin country. This arrangement save costs and simplifies the service, since that roaming subscriber will not get services from an operator in a foreign country.

From this data network 407, the communication signal is transferred directly via the data communication channel 405, or via Internet 409 or via a PSTN data channels to a multiplexer (/demultiplexer) platform 309 which identifies the cellular operator to which cellphone 105 belongs and transfers the initiated call to the cellular switch of that operator, for identifying that call and forwarding its data to the corresponding billing center 311, according to the cellular network used by the subscriber.

### The Networks Multiplexer

The Networks Multiplexer 309 is the instrument for providing network integration. A conventional cellular network is designed to support from thousands to tens of thousands of base stations. On the other hand, the deployment of millions of DAD subscribers (each of which is introduced to the cellular network as a type of base station) should comply with the ITU E911 regulation. Therefore, a new Multiplexer is required, which acts as a single access point from the mobile operator's switch to all DI subscribers. By doing so, the connection between the mobile operator's switch to all DI subscribers will have priority for obtaining services thorough the connection multiplexer, rather than through the traditional cellular network (since the traditional network is not designed to handle so many base stations).

The call is then diverted to a PSTN in any conventional manner, for connecting the subscriber to the destined recipient 313. Once communication between the subscriber and the destined recipient is established, the voice data is transferred to the subscriber's cellphone 105 in the opposite direction by a similar reverse way. In any case, the BS 103 which forwards the request for connection is in data communication with the switch of the relevant cellular operator, in order to verify that the subscriber has been given priority to be connected via data network 407. Otherwise, he will be connected via the cellular network. In addition, in order to maintain the required quality of service, the subscriber connects first via the regular cellular network and once priority is given to connect him via a DAD, the call is diverted from the base station to the DAD in a seamless way to avoid any discontinuity in the initiated call. A similar procedure of call diversion from the base station to the DAD in is carried out by the NM and the cellular switch when a subscriber receives an incoming call.

According to one embodiment of the present invention, a user of a cellular operator who is a subscriber of the service is able to travel to any country and to connect the adapter 403 to any socket of a telephone line that supports data (e.g.: ASDN, ADSL,) or to an access point to another network (e.g.: CATV) capable of exchanging data to register his cellphone to the service of his cellular provider in his home-country, rather than the local cellular provider. This implies that the subscriber that, even in a foreign country, he is still using his local number and his operator local charges.

Another advantage of the system proposed by the present invention is that the DADs can allow subscribers to get cellular services in areas that are not covered by any cell (e.g., settlements with small population, particularly in distant regions). Since almost any population uses PC and is connected to a data channel to have access to the Internet, each cellular provider can serve the population in distant regions by routing their calls through one or more DADs, rather than installing a base station in that region for few subscribers only.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. System for reducing the amount of RF radiation within a cell of a cellular network located in an urban area and servicing users of cellphones, comprising:
a) a plurality of dedicated access devices, each of which connected to a data network via an access point deployed in the vicinity of users, for:
a.1) detecting and communicating with subscribers, being users of cellphones with a unique identifier that are within its communication range;
a.2) upon detecting said unique identifier, diverting cellular calls of subscribers to which priority has been given, from the BS of said cell to data channels of said data network;
b) a multiplexer connected to said data channels, for identifying the corresponding cellular operator of each subscriber and routing said cellular calls to the cellular switch of said corresponding cellular operator.

2. System according to claim 1, in which the data network communication is:
ADSL;
ADSN;
Ethernet;
CATV;
WiFi;

3. System according to claim 1, in which the dedicated access device includes at least:
a) a transceiver for communicating with the cellphones of subscribers;
b) a filter for detecting unique identifiers and provide access only to subscribers with a unique identifier;
c) a software component for controlling data transfer between the data channel and the cellphones of subscribers; and
d) a voice gateway for converting RF signals to voice packets and vice versa.

4. System according to claim 1, in which the unique identifier is downloaded wirelessly into the SIM of the cellphone of the subscriber.

5. System according to claim 1, in which the unique identifier is deployed in a format that complies with the IMSI.

6. System according to claim 1, in which the dedicated access device provides roaming services to a subscriber by allowing the multiplexer being connected to a cellular provider in a foreign country to connect said subscriber to the switch of the cellular provider in his origin country.

7. System according to claim 1, in which the unique identifier is allocated to a subscriber by his cellular provider.

8. System according to claim 7, in which the unique identifier comprises a generic portion that can be detected by any dedicated access device.

9. System according to claim 1, in which the dedicated access device emulates a mini-base station of a cell.

10. System according to claim 1, which provides cellular connection to subscribers being in an area which is not covered by a cell through one or more dedicated access devices connected to a data network in said area.

11. System according to claim 1, in which the registration process of subscribers' cellphones is performed to one or more dedicated access devices connected to a data network.
